(19) United States
(12) Patent Application Publication
(10) Pub. No.: US 2023/0136696 A1
(43) Pub. Date: May 4, 2023

(54) SCORING METHOD WITH RFM-S

(71) Applicant: BORUSAN MAKINA VE GUC SISTEMLERI SANAYI VE TICARET ANONIM SIRKETI, Istanbul (TR)

(72) Inventors: Tayfun OZCAY, Gebze/Kocaeli (TR); Esra AKCA, Gebze/Kocaeli (TR); Yasin DINC, Gebze/Kocaeli (TR); Semra ERPOLAT TASABAT, Istanbul (TR)

(73) Assignee: BORUSAN MAKINA VE GUC SISTEMLERI SANAYI VE TICARET ANONIM SIRKETI, Istanbul (TR)

(21) Appl. No.: 17/908,692

(22) PCT Filed: Jul. 13, 2020
(86) PCT No.: PCT/TR2020/050620

§ 371 Date: Sep. 1, 2022

(30) Foreign Application Priority Data
Mar. 2, 2020 (TR) 2020 03219

(51) Int. Cl. G06Q 30/0201; G06Q 10/0637

(52) U.S. Cl. CPC G06Q 30/0201; G06Q 10/0637

(57) ABSTRACT

The invention, relates to a RFM-S scoring system and method, which enables the management of customer data on increasing the customer’s sustainability and loyalty to the company, and the prediction of future behavior of the consumer on the basis of products and services.

### TECHNICAL FIELD

The present invention, relates to a method which enables the management of customer data on increasing the customer’s sustainability and loyalty to the company, and the prediction of future behavior of the consumer on the basis of products and services.

More specifically, the present invention relates to a method that allows customers to be better known, to follow the changes in the economy, and to increase the savings of companies' money and time.

### PRIOR ART

With the development of technology and the widespread use of the Internet, the concept of Big Data has emerged. Big data can be briefly defined as an unstructured data stack and aims to transform the data collected from different sources into a meaningful and processable form. It focuses on what to do with it, rather than how much information there is. Big data analysis enables smart decisions to be made by analyzing large amounts of data.

Big data analysis, which includes a wide range of solutions, may cover different methods according to the subject. Data analysis is a process that turns a mass of information into structured information to make marketing decision. One of these methods is RFM analysis.

RFM analysis is an acronym for Recency, Frequency and Monetary, and is an effective and practical marketing model that performs customer-based segmentation. RFM analysis reduces marketing cost by the means of optimal targeting. It reduces negative reactions from customers by the means of controlled targeting.

The main premise is based on the view that customers who shop, shop frequently and provide high returns on their purchases will be potential customers who can return positively to their future marketing campaigns. In other words, it is an analysis model used to determine the target customer group that is likely to respond to new proposals to be placed on the market.

With these developments PESTEL analysis is used during strategic analysis or market research. PESTEL analysis reveals a conclusion about macro-level environmental factors that an enterprise should consider. In addition to RFM analysis, a new analysis model was developed as RFM-S, in which the impressive factors in PESTEL analysis were added to the RFM analysis as a variable and that the company and customers were understood more efficiently.

The existing methods do not allow digital tracking of the visit plan of the customers, which are more valuable in terms of purchase frequency and sales potential. Therefore, it cannot offer the ideal plan in terms of customer relations, and also inefficient travel planning occurs.

As a consequence of that the economical sensitivity variable, which is one of the impressive factors in PESTEL analysis, was required for the development of a new analysis model as RFM-S by participating in RFM analysis.

The document US20140310060A1 mentions a scoring method including ‘Recency’, ‘Frequency’ and ‘Monetary’ values. However, in addition to RFM analysis, RFM-S score analysis, which is a new analysis method resulting from the participation of economical sensitivity variable in RFM analysis, which is one of the impressive factors in PESTEL analysis, is not mentioned.

The document WO2008064343A1 mentions a RFM score based on the past transactions of the customer. However, in addition to RFM analysis, RFM-S score analysis, which is a new analysis method resulting from the participation of economical sensitivity variable in RFM analysis, which is one of the impressive factors in PESTEL analysis, is not mentioned.

The document US10204349B2 mentions an analysis of the customer’s income, spending habits, geo-demographic features and RFM values. However, sales estimation is not mentioned by conducting RFM-S score analysis created using the frequency, money, recency and environmental sensitivity variables of the customers.

The document US6839682B1 mentions that the customers' estimates of the expenditure history are classified as indispensable and arbitrary, but also by segmenting with other customers. However, sales estimation is not mentioned on the RFM-S score, which is created using frequency, monetary, recency and environmental variables of customers.

Consequently, the need for the analysis of customers' behaviors, a score analysis based on the data obtained from the customers, thus providing campaigns and services to the high potential customers in less time, and the formation of a beneficial seller-customer relationship with the speed of sale required the emergence of the solution according to the present invention.

### OBJECTIVES AND SHORT DESCRIPTION OF THE INVENTION

The aim of the present invention to introduce a method that provides convenience in the field of marketing, and saves money and time in companies.

The aim of the present invention to provide a method that allows customers to identify a new service, suggestion or campaign that is likely to respond to the trend.

Another aim of the invention is to reveal a method that enables higher estimation level by adding variables included in PESTEL analysis to RFM analysis.

In order to achieve the above aims, the present invention; provides a method that allows digital follow-up of the customers' visit plan, which is more valuable in terms of purchase frequency, sales potential and economic sensitivity.

The RFM-S scoring system of the present invention comprises,
at least one economy database that allows retrieving the data of US dollar rate of change and mortgage loan rate of change,
a CRM database that allows the storage and processing of data from various customers,
at least one server that allows the processing of data obtained from the database and the mathematical equations to be run in at least one software program using this data

Also in the method of the invention; A RFM-S scoring method comprises the following process steps:
initiating flow,
retrieving data from databases,
understanding and clearing data,
calculating of recency, sensitivity, frequency and monetary scores,
using the calculated scores in the equation
displaying of RFM-S scores obtained from the equation,
sharing the results with the sales representative
RFM-S scoring is completed and the flow is terminated

In the RFM-S scoring method, the equation is characterized by

$$\begin{matrix}\left(R e c e n c y S c o r e ∗ 1000\right) + \left(S e n s i t i v i t y S c o r e ∗ 100\right) + \\ \left(F r e q u e n c y S c o r e ∗ 10\right) + \left(M o n e t a r y S c o r e\right)\end{matrix}$$

### SHORT DESCRIPTION OF THE FIGURES

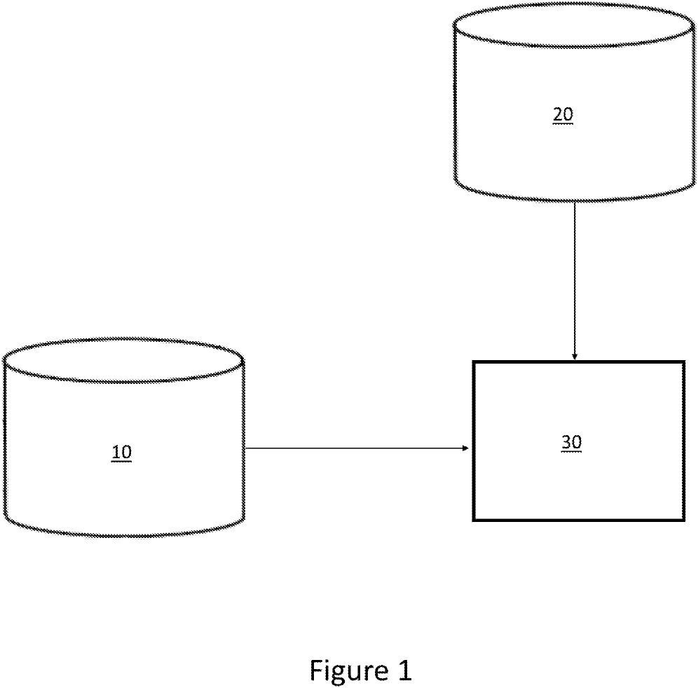

In FIG. 1, system components of the method subject to the invention and interaction between them are shown.

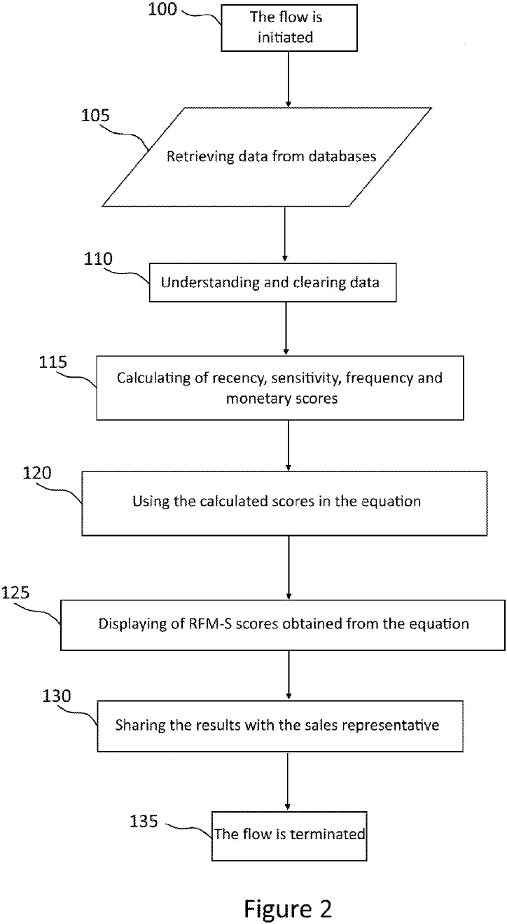

In FIG. 2, a flow diagram including the process steps related to the method subject to the invention is given.

### REFERENCE NUMBERS

10. Economy database
20. CRM database
30. Big data server
100. Flow initiates
105. Retrieving data from databases
110. Understanding and clearing data
115. Calculating of recency, sensitivity, frequency and monetary scores
120. Using the calculated scores in the equation
125. Displaying of RFM-S scores obtained from the equation
130. Sharing the results with the sales representative
135. Flow terminates

### DETAILED DESCRIPTION OF THE INVENTION

Nowadays, sales personnel determine the customers to visit and follow the route they have determined during transportation. The financial values of the customers are determined by the opportunities and the sensations obtained that have the potential to sell separately from the distance. Customers with higher financial importance, such as customers who are heavily traded in sales or service, need to be more sensitive, such as frequent visits to customers.

With the method of the invention, it is possible to follow the visit plan of the customers, which are more valuable in terms of purchase frequency and sales potential, and thus, the most ideal plan in terms of customer relations is provided and an efficient journey planning is realized.

With the method of the invention, according to the values of the customers' visit needs, the best visit plan is created in terms of business. A system that will control the importance of the customer with the economic sensitivity, turnover, profitability, last purchase date and number of sales parameters about the customer and create the visit plan accordingly will play an important role in increasing sales efficiency and increase customer satisfaction.

In the present invention, in addition to RFM analysis, the scoring method with RFM-S emerges by integrating the impressive factors in PESTEL analysis under the name sensitivity variable. The variables integrated and found meaningful from PESTEL analysis express the movements of exchange rates, sectoral loan rates and growth rates of countries. By integrating the sensitivity variable into RFM analysis, more accurate estimation is made on the customers.

In interpreting the RFM-S analysis of the invention, it is expected to prevent customer loss at the beginning. Thereafter, it makes predictions about the future behavior of the consumer on the basis of products and services. With RFM-S scoring, the customers are grouped as “how close”, “how often”, how much they bought ”,“ what are their economic and environmental sensitivities?”

$$\begin{matrix}\left(R e c e n c y S c o r e ∗ 1000\right) + \left(S e n s i t i v i t y S c o r e ∗ 100\right) + \\ \left(F r e q u e n c y S c o r e ∗ 10\right) + \left(M o n e t a r y S c o r e\right)\end{matrix}$$

As seen from the equation, the explanations of the variables used in the analysis are given below:
Recency Score: customer’s recency rate
Sensitivity Score: the country’s average past quarterly US dollar rate of change and mortgage loan rate of change,
Frequency Score: customer shopping frequency,
Monetary Score: the total amount paid by the customer

In the equation, “Recency Score, Sensitivity Score, Frequency Score, Monetary Score”; recency rate, past exchange rates, frequency and total amounts are divided into five equal 20% ranges, each with a value of 100%. It is calculated by giving 5 points to the highest 20%, 4 to the second highest, 3 to the third, 2 to the second and 1 to the lowest. The scale of these values is the lowest level 1 is the weakest customer and 5 is the most valuable customer. Companies can decide on which of recency, sensitivity, frequency and monetary values and intervals are the most ideal and change. Thus, the interval determination and scoring method can be arranged according to the requests of the companies that will apply the analysis.

In FIG. 1, system components of the method subject to the invention and interaction between them are shown. The system is generally contains; at least one economy database (10) containing dollar exchange rate and loan rate data extracted from the central bank electronic data distribution service, a CRM (Customer Relationship Management) database (20) containing information about the last shopping date, frequency of purchases and the total amount paid by the each customer who made purchases from the company, at least one big data server (30) where the data obtained from the database is processed and mathematical equations are run in the Python software program using this data.

A flow diagram that summarizes the process steps of the method is given in FIG. 2. First, the flow is initiated (100). US dollar rate of change and mortgage loan rate of change from economy database (10) and data such as the last shopping date of the customers, the frequency of the shopping and the total amount paid for the shopping from the CRM database (20) are retrieved (105). Understanding and clearing the data is performed upon the merging of existing data that occurred in the past months (110). Calculation of recency, sensitivity, frequency and monetary scores is performed (115). By using the calculated scores in the equation, each client’s RFM-S score results (120). The graphical result of the RFM-S scores of each customer is displayed (125). The meaningful data of the customers is shared with the sales representative (130). The RFM-S scoring is completed and the flow is terminated (135).

As an example of the method, it is provided to make inferences from the fluctuation of the purchasing situation of the customers over the economic factor. It helps to make a more accurate decision about who the future customers can be with economic conditions. In the RFM-S scoring method, it is seen that the changes in the US dollar rate are quite effective on the number of sales. Thus, the percentages of change in monthly, quarterly, annual US dollar sales rate and housing loan interest rates on the monthly sales frequencies of the data used in the analysis are included in the analysis. It is seen that the quarterly rate of change has more breaks compared to the annual rate of change and these breaks make a closer estimate. By means of the annual change percentage has more general fluctuations, a lower percentage estimate is to emerge. For this reason, the use of the quarterly change percentage gives closer results in the next month forecast when performing RFM-S scoring analysis.

1. A RFM-S scoring system that allows digital follow-up of the customers’ visit plan, which is more valuable in terms of purchase frequency, sales potential and economic sensitivity characterized in that it comprises
at least one economy database (10) that allows retrieving the data of US dollar rate of change and mortgage loan rate of change,
a CRM database (20) that allows the storage and processing of data from various customers,
at least one server (30) that allows the processing of data obtained from the database and the mathematical equations to be run in at least one software program using this data.

2. A RFM-S scoring system that allows digital follow-up of the customers’ visit plan, which is more valuable in terms of purchase frequency, sales potential and economic sensitivity characterized in that it comprises the following steps
the flow is initiated (100),
retrieving data from databases (105),
understanding and clearing data (110),
calculating of recency, sensitivity, frequency and monetary scores (115),
using the calculated scores in the equation (120),
displaying of RFM-S scores obtained from the equation (125),
sharing the results with the sales representative (130),
the RFM-S scoring is completed and the flow is terminated (135).

3. An RFM-S scoring method according to claim 2 wherein the equation is defined as
$$\begin{matrix}\left(R e g e n c y S c o r e ∗ 1000\right) + \text{} \left(S e n s i t i v i t y S c o r e ∗ 100\right) + \\ \left(F r e q u e n c y S c o r e ∗ 10\right) + \left(M o n e t a r y S c o r e\right)\end{matrix}$$
.
